(19) United States
(12) Patent Application Publication
(10) Pub. No.: US 2014/0236483 A1
(43) Pub. Date: Aug. 21, 2014

(54) METHOD AND APPARATUS FOR DETERMINING TRAVEL PATH GEOMETRY BASED ON MAPPING INFORMATION

(71) Applicant: NAVTEQ B.V., Veldhoven (NL)

(72) Inventors: Jerome Beaurepaire, Berlin (DE); Marko Tuukkanen, Schlenzer (DE)

(73) Assignee: NAVTEQ B.V., Veldhoven (NL)

(21) Appl. No.: 13/770,679

(22) Filed: Feb. 19, 2013

(51) Int. Cl. G01C 21/36

(52) U.S. Cl. CPC G01C 21/3626
USPC 701/533

(57) ABSTRACT

An approach for determining the geometry of a path of travel of a vehicle based on mapping information is described. A map based projection platform processes and/or facilitates a processing of mapping information associated with at least one path of travel of at least one vehicle to determine a geometry of the at least one path of travel. The map based projection platform further determines one or more display parameters for causing, at least in part, a projection of navigation information, safety information, or a combination thereof for the at least one vehicle based, at least in part, on the geometry.

### BACKGROUND

Service providers are continually challenged to deliver value and convenience to consumers by, for example, providing compelling network services. One area of interest is providing drivers with useful tools and services for enhancing the driving experience. By way of example, some vehicles are equipped with navigation systems, heads up displays and other systems for conveying traffic and safety related information to drivers pertaining to a given path of travel (e.g., roadway). Typically, these systems operate in connection with various inline sensors of the vehicle, which acquire data related to the vehicle or current traffic conditions (e.g., speed, proximity of the vehicle to others, altitude). Unfortunately, these systems are limited in their ability to account for the road geometry of the path of travel as a means of generating safety or traffic information for the driver or other nearby drivers.

### SOME EXAMPLE EMBODIMENTS

Therefore, there is a need for determining the geometry of a path of travel of a vehicle based on mapping information.

According to one embodiment, a method comprises processing and/or facilitating a processing of mapping information associated with at least one path of travel of at least one vehicle to determine a geometry of the at least one path of travel. The method further comprises determining one or more display parameters for causing, at least in part, a projection of navigation information, safety information, or a combination thereof for the at least one vehicle based, at least in part, on the geometry.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of mapping information associated with at least one path of travel of at least one vehicle to determine a geometry of the at least one path of travel. The apparatus is further caused to determine one or more display parameters for causing, at least in part, a projection of navigation information, safety information, or a combination thereof for the at least one vehicle based, at least in part, on the geometry.

According to another embodiment, a computer-readable storage medium carries one or more sequences of one or more instructions which, when executed by one or more processors, cause, at least in part, an apparatus to process and/or facilitate a processing of mapping information associated with at least one path of travel of at least one vehicle to determine a geometry of the at least one path of travel. The apparatus is further caused to determine one or more display parameters for causing, at least in part, a projection of navigation information, safety information, or a combination thereof for the at least one vehicle based, at least in part, on the geometry.

According to another embodiment, an apparatus comprises means for processing and/or facilitating a processing of mapping information associated with at least one path of travel of at least one vehicle to determine a geometry of the at least one path of travel. The apparatus further comprises means for determining one or more display parameters for causing, at least in part, a projection of navigation information, safety information, or a combination thereof for the at least one vehicle based, at least in part, on the geometry.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for determining the geometry of a path of travel of a vehicle based on mapping information, according to one embodiment;

FIG. 2 is a diagram of the components of a map-based projection platform, according to one embodiment;

FIGS. 3A-3E are flowcharts of processes for determining the geometry of a path of travel of a vehicle based on mapping information, according to various embodiments;

FIGS. 4A-4C are diagrams of a vehicle configured to present traffic or safety related display parameters based on the processes of FIGS. 3A-3E, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for determining the geometry of a path of travel of a vehicle based on mapping information is disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to the presentment of safety or travel related information for drivers, it is contemplated the approach described herein may be used to accommodate any information display needs of users (e.g., drivers) including event information, news information, image data or the like. Also, while various embodiments are described with respect to the use of an external system for projecting safety or travel related information including various two and three-dimensional displays or laser based transmitters, it is contemplated the approach described herein may apply to internal projection systems such as via a heads up display or an augmented reality based display system.

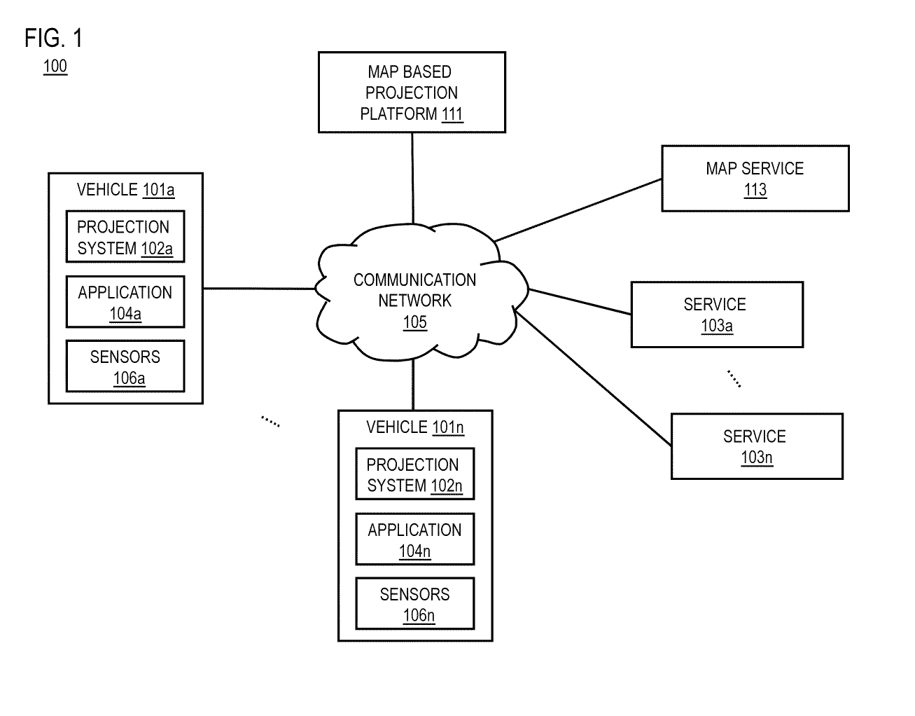

FIG. 1 is a diagram of a system capable of determining the geometry of a path of travel of a vehicle based on mapping information, according to one embodiment. By way of example, a path of travel may include a roadway, street, highway, trail or any other course upon which a vehicle may traverse from one location to another. Today, many vehicles are equipped with navigation systems, projection systems, heads up displays and other systems for conveying traffic and safety related information to drivers as they drive along a given path of travel. Typically, these systems operate in connection with various inline sensors of the vehicle, which acquire data related to the vehicle or data regarding current traffic conditions (e.g., speed, proximity of the vehicle to others, altitude).

However, these systems are limited in their ability to account for the road geometry of the path of travel. Consequently, the safety or traffic information to be displayed to the driver as one or more display parameters during travel is usually static and/or not presented within the field of view of the driver/path of travel. In addition, the display parameters may not coincide with the current characteristics of the road relative to the motion/action of the vehicle or other vehicles, i.e., for accounting for physical or environmental conditions relating to the path of travel. For example, a display parameter for indicating a stalled vehicle some yards ahead may be projected to a heads up display (HUD) of the driver's vehicle in an offset position (e.g., the corner of the display) as opposed to being presented relative to the stalled vehicle. As another example, in the case of a winding road where the driver's view of objects ahead is obstructed, a laser projected warning signal for suggesting that the driver slow down may be projected onto the physical roadway in a manner that is offset from the actual point of occurrence of the bend. There is currently no convenient solution for enabling the determination of vital road geometry metrics for affecting the placement of said display parameters based on data other than available sensor data. Still further, there is currently no convenient system for enabling the adapting of display parameters generated in response to mapping information for one vehicle based on the generation of display parameters for another vehicle.

To address this problem, a system 100 of FIG. 1 introduces the capability for vehicles 101a-101n configured with a laser/light based projection system, heads up display (HUD), augmented reality display mechanism, or the like (e.g., projection system 102a-102n) to convey display parameters based on mapping information associated with the path of travel. The path of travel may include a roadway, highway, street, trail, path, throughway or any other route correlating to the mapping information. As will be discussed more fully herein, the vehicle 101 may be configured to operate in connection with a map based projection platform 111 for enabling the generation of said display parameters corresponding to the path of travel per the mapping information. Also, for the purpose of illustration herein, the mapping information may include map data, route information, navigation directions, location information, points of interest associated with respective locations and any other details associated with the path of travel of the vehicles 101.

In one embodiment, the map based projection platform 111 may be implemented as a network/hosted service of the driver of the vehicle. Under this scenario, the driver may register with a provider of the map based projection platform according to a user agreement. The agreement may include a specification of the vehicle 101, the activation of an application 104a-104n (referred to herein collectively as applications 104), or the like for supporting the accessing of the platform 111 via a communication network 105. The application 104 may also be a utility of a navigation system of the vehicle, wherein the application 104 supports various interfaces for communicating with the map based projection platform 111. Alternatively, the map based projection platform 111 may be implemented as an onboard system of the vehicle 101 for facilitating the retrieval of mapping information as well as other contextual information. It is noted that the exemplary embodiments described herein may pertain to either implementation of the map based projection platform 111. Furthermore, it is noted that for either implementation, the map based projection platform 111 may support various protocols for enabling wireless, network or radio based communication, i.e., for accessing one or more services 103a-103n and 113 or for interacting with other vehicles configured to the platform 111.

In another embodiment, the map based projection platform 111 retrieves mapping information related to the vehicle 101 based on its current location. For example, the map based projection platform 111 may trigger the execution of one or more sensors 106a-106n (referred to herein as sensors 106) to acquire current location and/or position information of the vehicle 101. In addition, the sensors may gather weather or traffic related information. Under this scenario, the one or more sensors 106 may be controlled by the application 104, which may feature instructions for activating/deactivating the sensors 106 in response to a navigation request or requirements of the projection system 102. By way of example, in addition to location sensors, it is noted the sensors 106 may include orientation sensors for retrieving position data, an altimeter for retrieving altitude data, a light sensor for retrieving light intensity data, a timing sensor for retrieving temporal information, a speedometer for retrieving speed information, or a combination thereof. It is noted the above described contextual information may be transmitted to the map based projection platform 111, i.e., directly or remotely per the application 104 accordingly.

Once retrieved, in another embodiment, the map based projection platform 111 processes the mapping information to determine various characteristics of the current path of travel of the vehicle 101. Processing of the mapping information may include, for example, analyzing the mapping information against contextual data retrieved by the various sensors 106 of the vehicle 101 to determine the geometry of the path of travel. The geometry may pertain to the angle of curvature, turn radius, length, width, slope, or any other details relating to the configuration of the path of travel. In addition, the map based projection platform 111 may process the mapping information to determine the usage and/or type characteristics of the path of travel. This may include, for example, determining whether the path of travel is one-way, multi-lane, two-way, no-pass, associated with a specific district type or zone (e.g., business district, industrial zone), is an emergency lane or express lane, associated with specific speed limits or hazards (e.g., deer crossing), etc.

In another embodiment, the map based projection platform 111 may also be configured to access various third-party data providers (e.g., services 103a-103n) for retrieving and/or processing additional contextual information relating to a path of travel of the vehicle 101. This may include, for example, a weather information service, an event information service, a traffic information service, a social networking service or the like. Under this scenario, the map based projection platform 111 may further analyze this information to determine additional details related to the path of travel including known accidents, inclement weather conditions, traffic jams, other driver feedback information, etc. It is noted that, similar to the mapping service 113, the map based projection platform 111 may be configured to access the various services 103a-103n in connection with the vehicle 101 or driver thereof.

In another embodiment, the map based projection platform 111 determines one or more display parameters that are to be projected and/or otherwise displayed at the vehicle based on the determined geometry. In addition to the geometry, the display parameters are determined by the platform 111 based on the above described contextual information relating to the path of travel of the vehicle 101. Of note, the display parameters may include any current and/or predicted safety or navigation information associated with the path of travel of the vehicle 101. In addition, the information related to the geometry of the path of travel (e.g., the roadway type or curvature information) may be projected and/or otherwise displayed at the vehicle, i.e., to a heads up display.

By way of example, the display parameters determined by the platform 111 may include one or more visual elements and effects, text, patterns, icons, symbols, signals or the like for depicting various road conditions, weather conditions, traffic conditions and other safety related details pertaining to the vehicle 101 or vehicles along the same path of travel. As another example, the display parameters may include navigation information such as directions and point of interest information. In addition, the navigation information may include a suggested movement or action of the vehicle 101, a direction of the vehicle 101, a predicted movement or action of another vehicle along the same path (e.g., to within a predetermined proximity of the vehicle 101), etc.

In one embodiment, the display parameters may be output and/or projected externally, such as directly onto the path of travel by way of a laser based projection system (e.g., 102). It is further contemplated that the display parameters may be projected internally, such as to a heads up display 102 of the vehicle 101 or as an augmented reality view. By way of example, the map based projection platform 111 may facilitate optimal placement, sizing, movement, adjusting, or timing of the display parameters based on the geometry of the path of travel. Under this scenario, the projection is such that the display parameters are within the boundaries of the path of travel per the determined geometry. The boundaries may correspond to a field of view of the driver of the vehicle 101, such that the display parameters appear along the path of travel and are aligned with the physical objects encountered along the path. This is in contrast to the display parameters being offset from the path of travel when projected onto the road or onto the heads up display.

In another embodiment, the map based projection platform 111 also enables the adapting or updating of display parameters at one vehicle 101 based on the display parameters determined for another vehicle. This adapting corresponds to a synchronizing of the platform 111 across the vehicles traveling along the same path of travel based on the road geometry and the determined contextual information. By way of example, the platform 111 may determine the one or more display parameters of a first vehicle concurrent with a determination of the one or more display parameters for a second vehicle; both of which are travelling along the same path of travel and to within a certain proximity of one another.

Various use case scenarios are contemplated based on the above described execution of the map based projection platform 111. It is noted that for each of the various scenarios, the mapping information as retrieved from a service 113 is utilized to determine the appropriate geometry of the path of travel as opposed to reliance primarily upon sensors 102 or image recognition mechanisms. The mapping information may include, for example, two-dimensional data for representing characteristics of various paths of travel, three-dimensional model data for representing various street scenes, city scenes or the like, or a combination thereof. In addition, the geometry information is analyzed in connection with the contextual information for affecting the determination and/or generation of the display parameters. Still further, the display parameters may be appropriately sized, placed, moved (e.g., as the vehicle traverses the path) and illuminated to ensure it is visible to the driver within the boundaries of the actual path of travel as well as according to current lighting and/or weather conditions.

In one scenario, the map based projection platform 111 may be configured to operate in connection with the signal lights of a vehicle. Under this scenario, when the vehicle 101 is changing lanes, the signals trigger execution of the map based projection platform 111 such that the display parameters include an arrow for indicating the lane(s) required to be traversed. In addition, the display parameters may correspond to a projection of an area for representing the amount of space required for the vehicle 101 to perform the turn. It is noted that this may correspond, for example, to a laser based projection system 102, wherein one or more lasers are affixed to various points along the vehicle for transmitting focused light signals accordingly.

In another scenario, the map based projection platform 111 may support the entry of vehicles onto a busy path of travel, such as a highway. By way of example, the geometry of the highway may be determined by accessing mapping information, wherein the geometry enables the platform to determine the type of highway being entered, the number of lanes, the direction of traffic flow, the presence of a merge lane at the point of entry, etc. In addition, the platform 111 may analyze the geometry with respect to speed information pertaining to the vehicle or other vehicles passing by. As such, the platform 111 predicts an optimal amount of space required for entry into the current traffic queue (e.g., per the Zipper Effect) and determines a display parameter for representing this space and projecting it. It is noted that the display parameter may also be adaptive—i.e., decreasing area or increasing area—such as in response to changing speed and/or or proximity of incoming other vehicles near the point of entry relative to the geometry of the highway.

In another scenario, the map based projection platform 111 may be used in connection with a blind spot detection system, wherein the detection is performed by a front facing camera that enables the distance to the car to be calculated. Under this scenario, the detection system may estimate when a given vehicle is entering the blind spot of another vehicle based on the captured image data as well as based on the geometry of the path of travel per associated mapping information. By way of example, the estimated blind spot may be detected in instances where the curvature, altitude, grade, or other characteristic of the path of travel is subject to change.

In another scenario, the map based projection platform 111 may detect that the vehicle is partly in an emergency lane or outside the intended driving lane based on geometry. As a result, a warning message may be determined for projection by the heads up display for alerting the driver. Still further, the platform 111 may cause an adapting of the display parameters determined for other vehicles in response to the first vehicle. This adapting may include causing the updating of display parameters to be presented at or projected by the other vehicles, i.e., including projecting outward directly onto the path of travel from the various vehicles. It is noted also that the map based projection platform 111 may account for the relative positions of said vehicles, the number of vehicles, the relative speed of said vehicles and other factors for adjusting how or when the display parameter is projected by or for respective vehicles.

In yet another scenario, the map based projection platform 111 may determine display parameters for use in projecting lines to reflect the priority of vehicles at an intersection. For example, in the case where a first vehicle approaching an intersection is not slowing down as expected, a display parameter representing a warning for other drivers arriving to the same intersection may be projected. Under this scenario, the display parameter for placement within the intersection would only take place when the vehicle is approaching the intersection and is a certain distance from the intersection per the analysis of the mapping information, sensor information, etc.

As another scenario, a display parameter may be determined for warning when a vehicle's actual speed is significantly below a maximum or suggested speed limit of the path of travel. Per this scenario, the map based projection platform determines whether a difference between the actual speed and the upper speed limit for the current segment of the path is over a predetermined threshold. Once determined per this analysis, a display parameter for causing a projection of a warning for an oncoming vehicle to slow down may be determined. Alternatively, the projection may be directed behind the vehicle that is moving slowly, or may correspond to a suggested movement of the oncoming vehicle to switch lanes or overtake the slow moving vehicle.

In another scenario, the map based projection platform 111 may determine a display parameter for representing the space required by the vehicle while parking between respective other vehicles along the same path of travel, changing lanes to fit in-between respective vehicles, or the like. Under this scenario, the mapping information is utilized to determine the common geometric factors and characteristics of the road along with relative speed and/or distance information relative to the other vehicles to support generation of the appropriate display parameter. For example, in one scenario, using the contextual information pertaining to a first vehicle and the corresponding mapping information for the path of travel, the platform 111 may identify whether the first vehicle is on a collision course with another vehicle or whether it will be drifting out of is lane. Upon detection, the platform 111 may then use this information to affect the display parameters at the other vehicle, i.e., issue a warning to the other vehicle.

While the above described scenarios may pertain to external projection of the display parameters, such as per a laser based projection system 102, the map based projection platform 111 may also accommodate internal projection displays 102 such as a heads up display. In either case, the map based projection platform 111 may account for the current ambient light intensity, the boundaries of the path of travel, the angle of projection of the display parameters relative to the current movement of the vehicle and road geometry, weather conditions, etc. Of note, in the case of external projection of the display parameters, the navigation or safety information may be physically projected onto the path of travel to be viewed by other drivers without obstructing traffic or impeding driver visibility.

As shown in FIG. 1, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The vehicle 101 may be any type of passenger, commercial or industrial vehicle capable of travelling along a path of travel. In addition, the vehicle 101 may be equipped with user equipment for supporting navigation, and may be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the user equipment can support any type of interface to the user (such as “wearable” circuitry, etc.). In addition, the user equipment may execute the application 104 for enabling interaction with the map based projection platform 111.

By way of example, the application 104, map based projection platform 111, map service 113 and various services 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the vehicles 101, i.e., per the navigation system or application 104, other vehicles and the map based projection platform 111 is typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

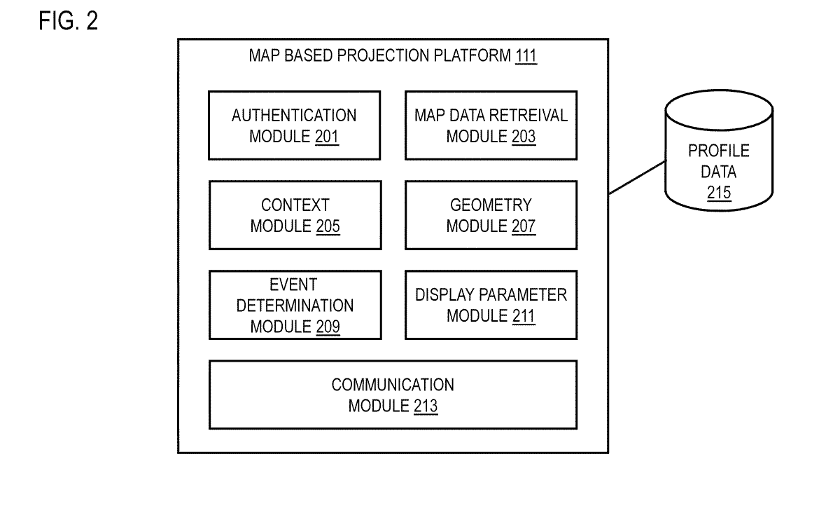

FIG. 2 is a diagram of the components of a map based projection platform, according to one embodiment. By way of example, the map based projection platform 111 includes one or more components for determining the geometry of a path of travel of a vehicle based on mapping information. It is contemplated that the functions of these components may be combined in one or more components or performed by other components of equivalent functionality. In this embodiment, the map based projection platform 111 includes an authentication module 201, map data retrieval module 203, context module 205, geometry module 207, event determination module 209, display parameter module 211 and communication module 213.

The aforementioned modules 201-215 of the map based projection platform 111 may also access a profile database 217 for maintaining profile information related to one or more drivers and/or vehicles 101 subscribed to and/or associated with the map based projection platform 111. It is noted that the profile information may further include subscription information regarding the various other services 103 and 113 associated with the driver.

In one embodiment, an authentication module 201 authenticates vehicles (e.g., equipped with an application 104) for enabling interaction with the map based projection platform 111. In addition, the authentication procedure may be performed with respect to service providers, such as a provider of the mapping service 113 or one or more data services 103. By way of example, the authentication module 201 receives a request to subscribe to the map based projection platform 111 and facilitates various subscription protocols. For a driver, this may include establishing one or more access credentials as well as “opting-in” to receiving data from specific providers of the services 103 or the map service 113. Under this scenario, the opt-in procedure may also enable drivers to permit sharing of their context information (e.g., location information, position information and temporal information) as collected via one or more sensors 106 of the vehicle 101. In addition, the procedure may include the loading or activating of the application 104.

It is noted, in certain embodiments, that the subscription process may be coordinated with a subscription process of a given service 103 accessed by a driver. For example, various input data required for a driver to subscribe to the mapping service 113 may be used for establishing profile data 117 for the map based projection platform 111; thus preventing the driver from having to perform redundant entry of their credentials.

The authentication process performed by the module 201 may also include receiving and validating a login name and/or identification value as provided or established for a particular driver during a subscription or registration process with the service provider. The login name and/or driver identification value may be received as input provided by the application 104, such as in response to a request for receipt of navigation information or safety information. Alternatively, the authentication module 201 may receive a signal from the application 104 for indicating the availability of current contextual details regarding the vehicle, i.e., the vehicle is in motion. As such, the authentication module 201 passes the contextual information to the context module 205 for processing. In turn, this initiates activation of the various other modules for facilitating the determining of the appropriate display parameters based on the path of travel of the vehicle 101.

In one embodiment, the map data retrieval module 203 retrieves mapping data from a map service based on the acquired context information related to the vehicle of the path of travel. For example, upon determining location information for the vehicle 101, the map data retrieval module 203 performs a query of the mapping service 103 to retrieve the associated mapping information. In addition, the map data retrieval module 203 may also access relevant data from the various other services 103, including a weather information service or traffic information service. Once collected, the information pertaining to the path of travel is passed on to the geometry module 207.

In certain embodiments, the geometry module 207 determines the geometry of the path of travel of the vehicle based on the processed contextual information per the context module 205 as well as the data collected from the various services 103. In addition, the geometry of the path of travel is determined based on the mapping information. The geometry may pertain to the angle of curvature, turn radius, length, width, slope, or any other details relating to the configuration of the path of travel. In addition, the map based projection platform 111 may process the mapping information to determine the usage and/or type characteristics of the path of travel, such as lane count, direction characteristics (e.g., two-way versus one-way), speed limits or hazard zones along the various segments of the path of travel (e.g., deer crossing), etc. It is noted, therefore, that the geometry module 207 enables the characteristics and configuration of the path of travel of the vehicle to be determined in real-time.

In one embodiment, the event determination module 209 receives feedback information and event data from various other vehicles subscribed to the map based projection platform 111. By way of example, the event determination module 209 determines whether another vehicle travelling along the same path of travel exhibits behavior warranting an adapting of the display parameters at another vehicle. This determination is based, at least in part, on a proximity condition between the respective vehicles. The event may correspond to navigation information, safety information, or a combination thereof. Hence, various event types may include an accident, a vehicle stalling, slow traffic, a direction of travel, presence of a point-of-interest, etc.

In certain embodiments, the event determination module 209 operates in connection with the display parameter module 211, which analyzes the geometry and contextual information to generate and/or determine one or more corresponding display parameters. Hence, per this scenario, the display parameter module 211 determines which display parameter type corresponds to the event type for the one or more vehicles along the path. In addition, the display parameter module 211 determines a sizing, placement, illumination, motion, coloring or other characteristics of the display parameter for enabling its projection within the boundaries of the path of travel. It is noted that the display parameter module 211 may further transmit the determined display parameter—in the form of instructions or as one or more textual/visual elements—via the projection system 102 of the vehicle to initiate presentment of the parameter. Hence, the display parameter module 211 may operate in connection with any external or internal based projection or display system of a vehicle 101.

In one embodiment, a communication module 215 enables formation of a session over a network 105 between the map based projection platform 111, the mapping service 113, the vehicle 101 and the services 103. By way of example, the communication module facilitates the transmission of the display parameters, contextual information as retrieved from the application 104, etc., based on one or more known communication protocols.

It is noted that the above described modules of the map based projection platform 111 may be subsequently integrated for operation within a vehicle, preconfigured for operation within the vehicle (e.g., by the manufacturer), or the like.

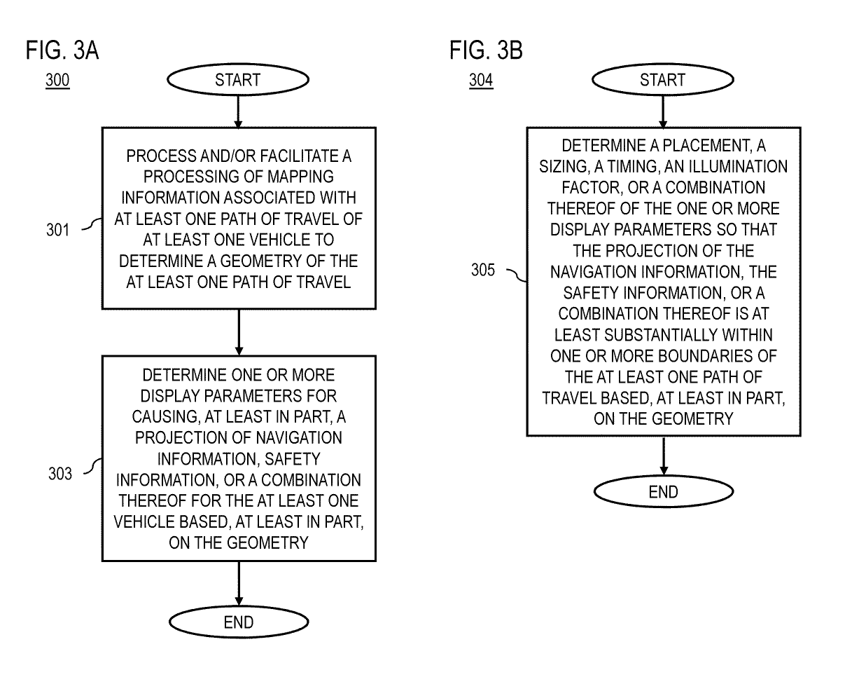

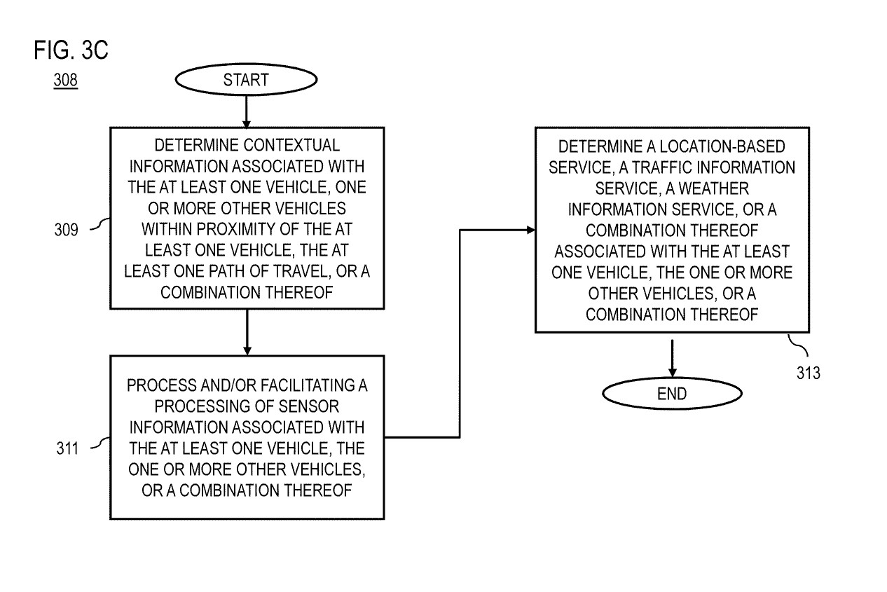

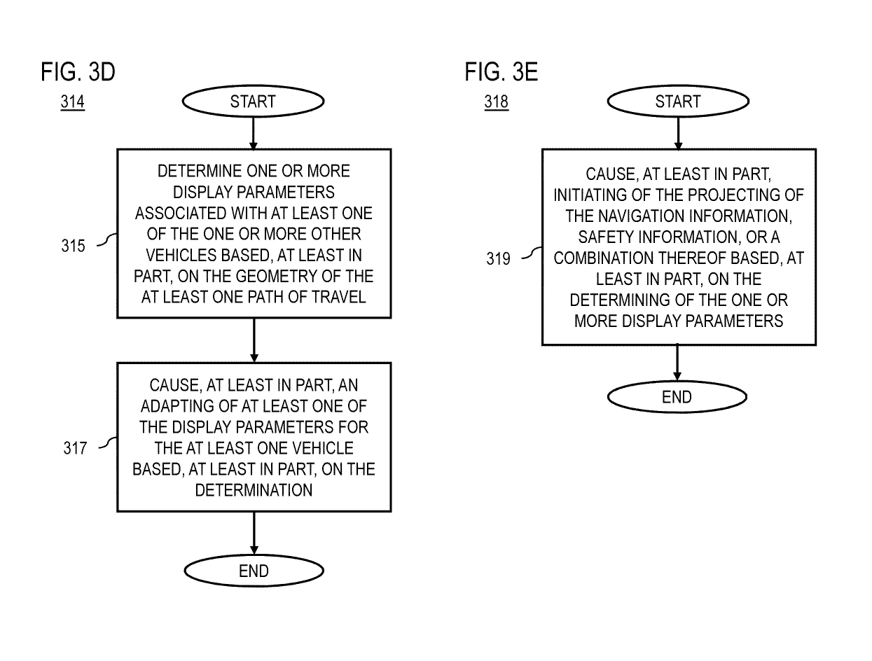

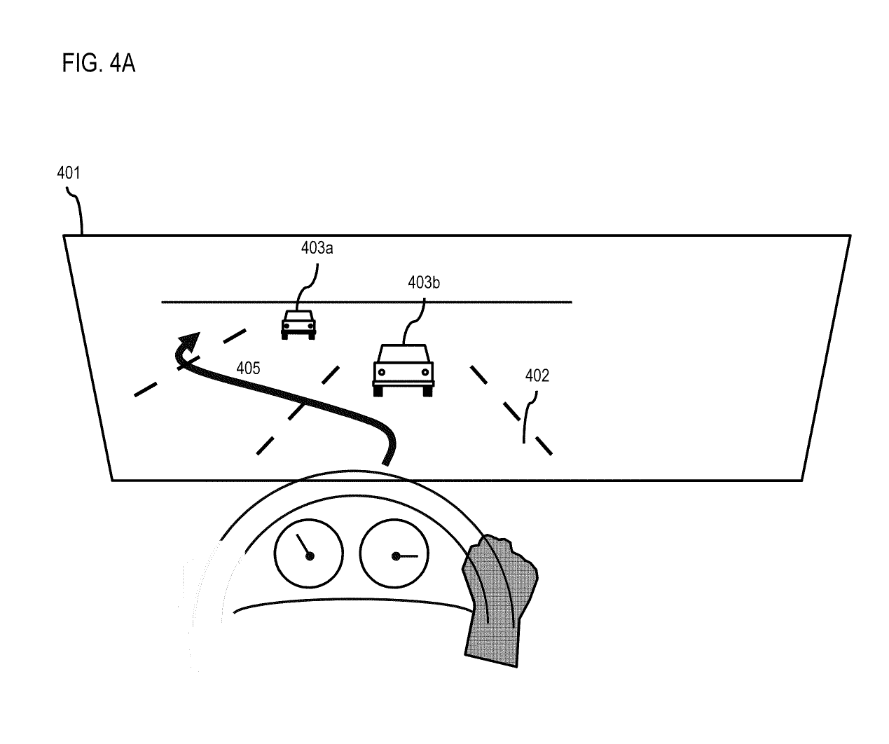

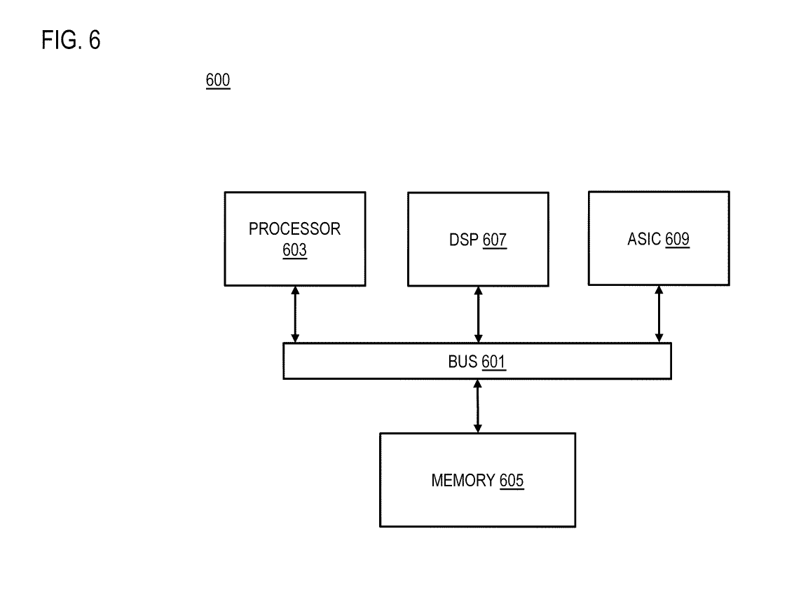

FIGS. 3A-3E are flowcharts of processes for determining the geometry of a path of travel of a vehicle based on mapping information, according to various embodiments. In one embodiment, the map based projection platform 111 performs processes 300, 304, 308, 314 and 318 and is implemented in, for instance, a chip set including a processor and a memory as shown in FIG. 6.

In step 301 of process 300 (FIG. 3A), the map based projection platform 111 processes and/or facilitates a processing of mapping information associated with at least one path of travel of at least one vehicle to determine a geometry of the at least one path of travel. As noted previously, the geometry may include any data for indicating the characteristics of configuration the path of travel such as an angle of curvature, length, number of lanes, road class or type, etc. In step 303, the platform 111 determines one or more display parameters for causing, at least in part, a projection of navigation information, safety information, or a combination thereof for the at least one vehicle based, at least in part, on the geometry.

As noted, the display parameters may include one or more visual elements and effects, text, patterns, icons, symbols, signals or the like for depicting various road conditions, weather conditions, traffic conditions and other safety related details pertaining to the vehicle 101 or vehicles along the path of travel. Also of note, the determination may include the generation of the display parameters, a signaling to a display 102 and/or projection unit of the vehicle 101 to initiate the generation, or a combination thereof.

In step 305 of process 304 (FIG. 3B), the map based projection platform 111 determines a placement, a sizing, a timing, an illumination factor, or a combination thereof of the one or more display parameters so that the projection of the navigation information, the safety information, or a combination thereof is at least substantially within one or more boundaries of the at least one path of travel based, at least in part, on the geometry. As noted, the placement, sizing and other factors are determined to ensure maximal presentment of the display parameters within the field of view of the driver of the vehicle, i.e., within the boundaries of the path or along path. In addition, the placement may adapt in accordance with the real-time changes in contextual information related to the driver. For example, an object, symbol or alert for depicting or indicating that the vehicle is approaching an obstruction in the road may increase in size relative to the speed/distance between the vehicle and said obstruction. The adjustment of said object, symbol or alert may be managed by the projection system 102, the map based projection system, or a combination thereof.

In step 309 of process 308 (FIG. 3C), the map based projection platform 111 determines contextual information associated with the at least one vehicle, one or more other vehicles within proximity of the at least one vehicle, the at least one path of travel, or a combination thereof. In another step 311, the platform 111 processes and/or facilitates a processing of sensor information associated with the at least one vehicle, the one or more other vehicles, or a combination thereof. Still further, per step 313 the platform 111 determines a location-based service, a traffic information service, a weather information service, or a combination thereof associated with the at least one vehicle, the one or more other vehicles, or a combination thereof. As noted previously, the contextual information may include location information, traffic condition information, weather condition information, speed information, temporal information, distance information, proximity information, or a combination thereof.

In step 315 of process 314 (FIG. 3D), the map based projection platform 111 determines one or more display parameters associated with at least one of the one or more other vehicles based, at least in part, on the geometry of the at least one path of travel. Per step 317, the platform 111 causes, at least in part, an adapting of at least one of the display parameters for the at least one vehicle based, at least in part, on the determination. As noted, this corresponds to ability of the platform 111 to account for common navigation or safety related events/occurrences along the path of travel that affect the different vehicles.

In another step 319 of process 318 (FIG. 3E), the map based projection platform 111 causes at least in part, a projecting of the navigation information, safety information, or a combination thereof based, at least in part, on the determining of the one or more display parameters. As noted previously, the display parameters include a representation of (a) a direction of travel of the at least one vehicle, the one or more other vehicles, or a combination thereof, (b) a representation of a traffic warning associated with the path of travel, the at least one vehicle, the one or more other vehicles, or a combination thereof, or (c) a combination thereof. It is further noted that the projection may be internal, such as in relation to a heads up display, or external to the vehicle.

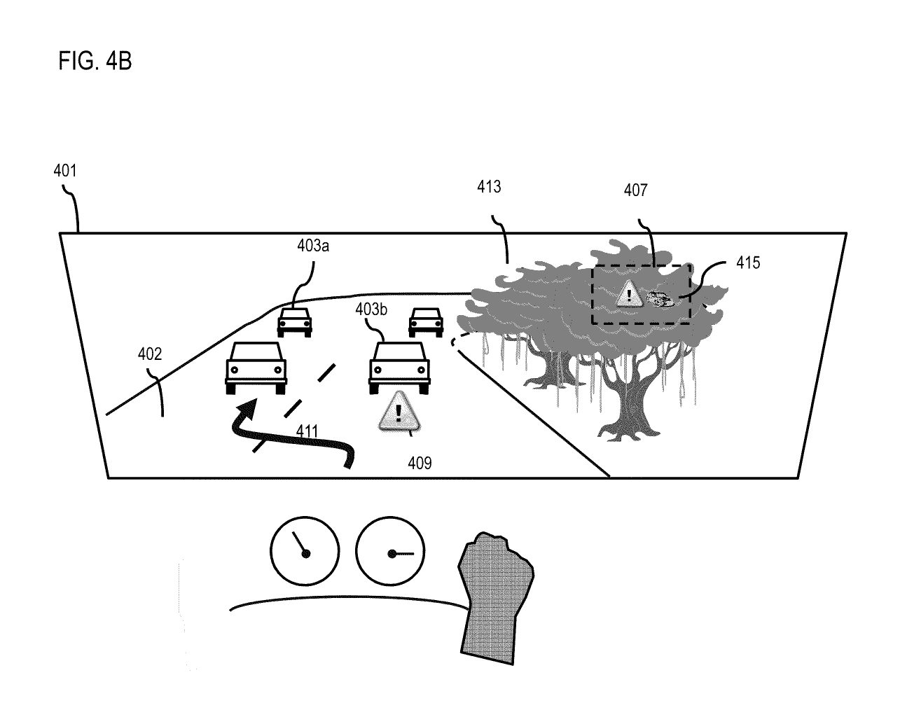

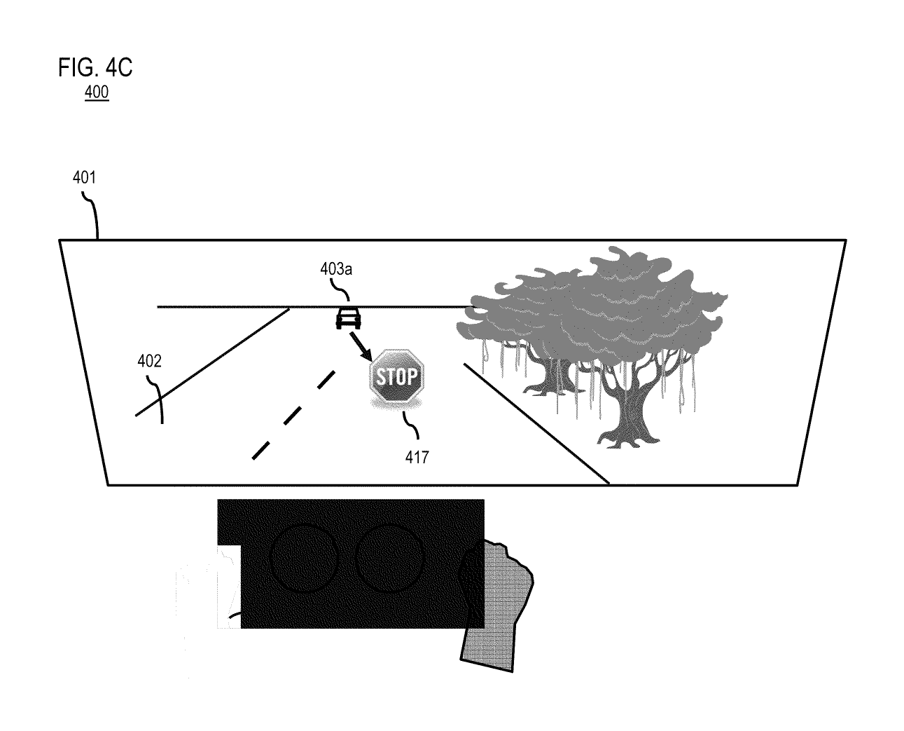

FIGS. 4A-4C are diagrams of a vehicle configured to present traffic or safety related display parameters based on the processes of FIGS. 3A-3E, according to various embodiments. For the purpose of illustration, the display parameter(s) are projected directly onto the path of travel of the vehicle, i.e., via a laser based projection system. Also, for the purpose of illustration, the display parameters are presented from a first person perspective of the driver, wherein the path of travel and various objects associated therewith is viewed by the driver during navigation. It is noted that the scenarios presented herein may also apply to a heads up display or any other projection means of the vehicle.

In FIG. 4A, the map based projection platform 111 retrieves mapping information relating to the current path of travel of the driver. Under this scenario, the path of travel is a multi-lane roadway that includes one or more other vehicles 403a and 403b within several of the lanes. The platform 111 processes the mapping information and associated contextual information for the vehicle and/or path of travel to determine a display parameter 405 to project to the road 402. The display parameter 405 corresponds to a suggested means of navigation of the vehicle, which in this case is presented in response to a navigation request of the driver. It is noted that the display parameter 405 is within the boundaries of the multi-lane road 402. Also, the suggestion is based on the known multi-lane geometry of the road, the current speed of the vehicle and/or proximity information pertaining to the other vehicles 403a-b.

Under this scenario, the display parameter 405 is projected from a projection system of the vehicle outward to the location along the path where the vehicle is to navigate. The platform 111 may determine the relative intensity of the beam for casting the display parameter 406 based on the known geometry of the road as well as temporal or weather condition information; for enabling the means of projection to be adapted to accommodate the driver as well as to limit the interference of other drivers.

In FIG. 4B, the map based projection platform 111 retrieves mapping information relating to the current path of travel of the driver along with various contextual information pertaining to the road 402. Based on processing of the mapping information as well as the contextual information, the platform 111 determines the road 402 is a two-lane, winding road. Also, based on the current position and speed of the vehicle, the vehicle is less than 300 yards or approximately 23 seconds away from the initial point of curvature of the road (based on the present speed of travel of the vehicle). Under this scenario, it is noted that various trees 413 obstruct the view of traffic beyond the curve in the road. This includes, for example, a stalled vehicle 415 that lies just beyond the bend in the road, which is not presently within view of the driver.

In addition to the mapping information, the platform 111 also retrieves traffic related information and to determine one or more traffic conditions associated with the road. Based on this contextual information, the platform 111 determines the presence of the stalled vehicle 415 as well as corresponding slowed traffic ahead (e.g., per vehicles 403a-403b) along the road 402. Resultantly, the platform 111 determines a display parameter 411 for suggesting the vehicle navigate to the left-most lane, which is opposite the lane in which the stalled vehicle 415 is located. The left-most lane is determined to be the least encumbered by the traffic based on the geometry of the road and the presence of the stalled vehicle 415.

In addition, other display parameters 407 and 409 are projected onto the road 402 for representing safety information. Display parameter 409 is projected to suggest that the driver slow down the vehicle due to the slow traffic conditions ahead. Similarly, display parameter 407 depicts an anticipated/predicted location of the stalled vehicle 415 around the bend in the road relative to the current position of the vehicle. Under this scenario, while the driver is not able to physically see the stalled vehicle 415, the display parameter 407 is placed along the roadway 402 and within view of the driver. As the driver approaches a point along the road where the stalled vehicle 415 is actually within view, this display parameter 407 may be removed from the heads up display 401 accordingly. Prior to arrival at this point, the platform 111 may adapt the size and/or position of the display parameter 407 commensurate with the approaching of the stalled vehicle.

In FIG. 4C, the map based projection platform 111 retrieves mapping information relating to the current path of travel of the driver of a first vehicle. In addition, the platform 111 interacts with a vehicle 403a that travels along the same road 402 towards the first vehicle. Based on processing of the mapping information and contextual information for the respective vehicles, the platform 111 determines the path 402 comprises two-lanes having opposing traffic flows. In addition, the platform 111 determines, based on the motion, speed and other factors associated with the oncoming vehicle 403a that it is on a collision course with the first vehicle or that the vehicle 403a will be drifting out of its lane. As a result, it is determined that the appropriate display parameter 417 be safety information for warning the driver of the oncoming vehicle 403a.

In this case, the projection as directed to the road is an alert for the driver to stop. In addition, the display parameter 417 is placed within the boundaries of the path for depicting a predicted point of impact based on the current speed and distance of the respective vehicles to one another. It is noted per this scenario that the platform 111 enables the driver of the vehicle to account for the unexpected behavior of the opposing driver of vehicle 403a. In addition, the display parameters as projected to a road 402 or even a heads up display 401 of the opposing vehicle 403a may also be adapted according to the response taken by the driver of the first vehicle.

The processes described herein for determining the geometry of a path of travel of a vehicle based on mapping information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

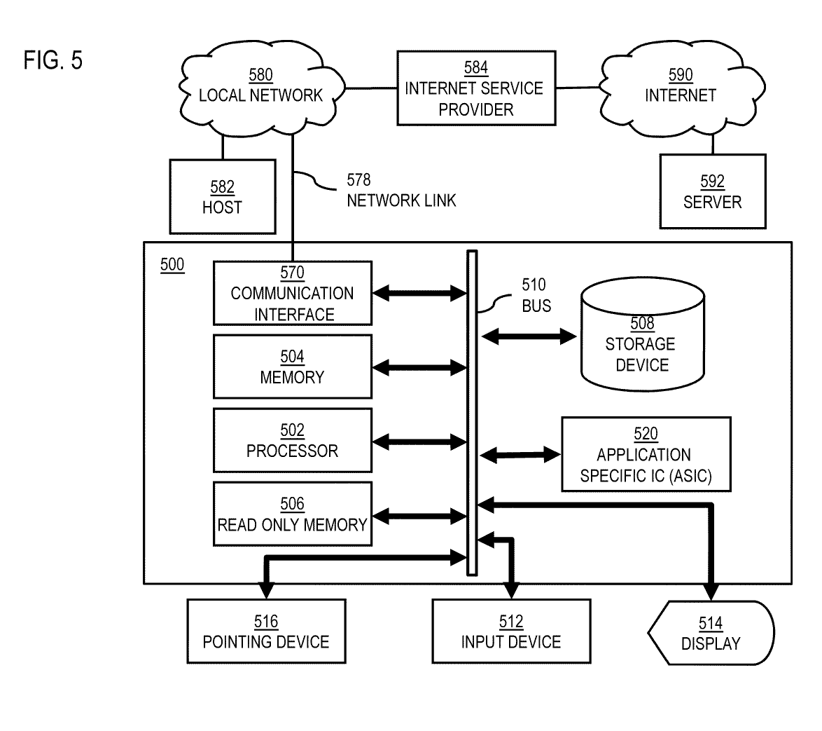

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to determine the geometry of a path of travel of a vehicle based on mapping information as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of determining the geometry of a path of travel of a vehicle based on mapping information.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to determine the geometry of a path of travel of a vehicle based on mapping information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for determining the geometry of a path of travel of a vehicle based on mapping information. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for determining the geometry of a path of travel of a vehicle based on mapping information, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for determining the geometry of a path of travel of a vehicle based on mapping information to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to determine the geometry of a path of travel of a vehicle based on mapping information as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of determining the geometry of a path of travel of a vehicle based on mapping information.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to determine the geometry of a path of travel of a vehicle based on mapping information. The memory 605 also stores the data associated with or generated by the execution of the inventive steps.

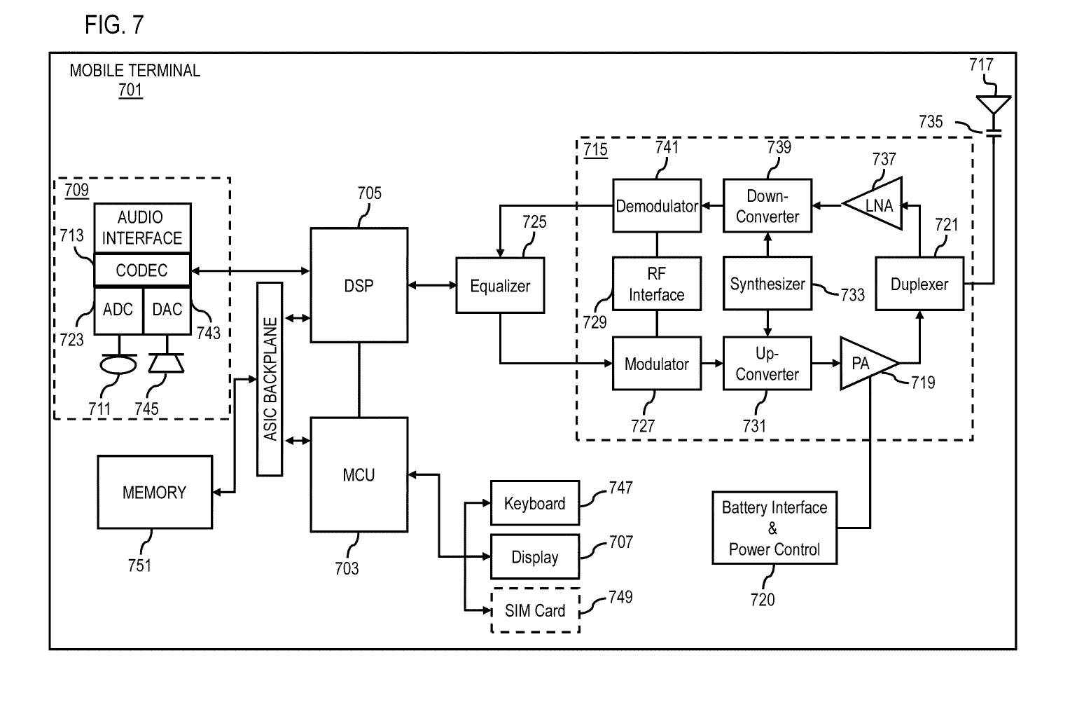

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of determining the geometry of a path of travel of a vehicle based on mapping information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the driver in support of various applications and mobile terminal functions that perform or support the steps of determining the geometry of a path of travel of a vehicle based on mapping information. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to determine the geometry of a path of travel of a vehicle based on mapping information. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of mapping information associated with at least one path of travel of at least one vehicle to determine a geometry of the at least one path of travel; and
at least one determination of one or more display parameters for causing, at least in part, a projection of navigation information, safety information, or a combination thereof for the at least one vehicle based, at least in part, on the geometry.

2. A method of claim 1, wherein the (1) data and/or (2) information and/or (3) at least one signal are further based, at least in part, on the following:
at least one determination of a placement, a sizing, a timing, an illumination factor, or a combination thereof of the one or more display parameters so that the projection of the navigation information, the safety information, or a combination thereof is at least substantially within one or more boundaries of the at least one path of travel based, at least in part, on the geometry.

3. A method of claim 2, wherein the one or more boundaries is associated with a field of view of at least one user of the at least one vehicle, a heads-up display of the at least one vehicle, an augmented reality representation of the path of travel, a projector of the at least one vehicle, or a combination thereof.

4. A method of claim 1, wherein the (1) data and/or (2) information and/or (3) at least one signal are further based, at least in part, on the following:
contextual information associated with the at least one vehicle, one or more other vehicles within proximity of the at least one vehicle, the at least one path of travel, or a combination thereof,
wherein the one or more display parameters are further based, at least in part, on the contextual information.

5. A method of claim 4, wherein the (1) data and/or (2) information and/or (3) at least one signal are further based, at least in part, on the following:
a processing of sensor information associated with the at least one vehicle, the one or more other vehicles, or a combination thereof,
wherein the determining of the contextual information is based, at least in part, on the sensor information.

6. A method of claim 5, wherein the (1) data and/or (2) information and/or (3) at least one signal are further based, at least in part, on the following:
at least one determination of a location-based service, a traffic information service, a weather information service, or a combination thereof associated with the at least one vehicle, the one or more other vehicles, or a combination thereof,
wherein the contextual information includes location information, traffic condition information, weather condition information, speed information, temporal information, distance information, proximity information, or a combination thereof.

7. A method of claim 1, wherein the (1) data and/or (2) information and/or (3) at least one signal are further based, at least in part, on the following:
at least one determination of one or more display parameters associated with at least one of the one or more other vehicles based, at least in part, on the geometry of the at least one path of travel.

8. A method of claim 7, wherein the (1) data and/or (2) information and/or (3) at least one signal are further based, at least in part, on the following:
an adapting of at least one of the display parameters for the at least one vehicle based, at least in part, on the determination.

9. A method of claim 7, wherein the (1) data and/or (2) information and/or (3) at least one signal are further based, at least in part, on the following:
an initiating of the projection of the navigation information, safety information, or a combination thereof based, at least in part, on the determining of the one or more display parameters

10. A method of claim 9, wherein the display parameters include a representation of (a) a direction of travel of the at least one vehicle, the one or more other vehicles, or a combination thereof, (b) a representation of a traffic warning associated with the path of travel, the at least one vehicle, the one or more other vehicles, or a combination thereof, or (c) a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of mapping information associated with at least one path of travel of at least one vehicle to determine a geometry of the at least one path of travel; and
determine one or more display parameters for causing, at least in part, a projection of navigation information, safety information, or a combination thereof for the at least one vehicle based, at least in part, on the geometry.

12. An apparatus of claim 11, wherein the apparatus is further caused to:
determine a placement, a sizing, a timing, an illumination factor, or a combination thereof of the one or more display parameters so that the projection of the navigation information, the safety information, or a combination thereof is at least substantially within one or more boundaries of the at least one path of travel based, at least in part, on the geometry.

13. An apparatus of claim 12, wherein the one or more boundaries is associated with a field of view of at least one user of the at least one vehicle, a heads-up display of the at least one vehicle, an augmented reality representation of the path of travel, a projector of the at least one vehicle, or a combination thereof.

14. An apparatus of claim 11, wherein the apparatus is further caused to:
determine contextual information associated with the at least one vehicle, one or more other vehicles within proximity of the at least one vehicle, the at least one path of travel, or a combination thereof,
wherein the one or more display parameters are further based, at least in part, on the contextual information.

15. An apparatus of claim 14, wherein the apparatus is further caused to:
process and/or facilitate a processing of sensor information associated with the at least one vehicle, the one or more other vehicles, or a combination thereof,
wherein the determining of the contextual information is based, at least in part, on the sensor information.

16. An apparatus of claim 15, wherein the apparatus is further caused to:
determine a location-based service, a traffic information service, a weather information service, or a combination thereof associated with the at least one vehicle, the one or more other vehicles, or a combination thereof,
wherein the contextual information includes location information, traffic condition information, weather condition information, speed information, temporal information, distance information, proximity information, or a combination thereof

17. An apparatus of claim 11, wherein the apparatus is further caused to:
determine one or more display parameters associated with at least one of the one or more other vehicles based, at least in part, on the geometry of the at least one path of travel.

18. An apparatus of claim 17, wherein the apparatus is further caused to:
cause, at least in part, an adapting of at least one of the display parameters for the at least one vehicle based, at least in part, on the determination.

19. An apparatus of claim 17, wherein the apparatus is further caused to:
cause, at least in part, an initiating of the projection of the navigation information, safety information, or a combination thereof based, at least in part, on the determining of the one or more display parameters.

20. An apparatus of claim 11, wherein the display parameters include a representation of (a) a direction of travel of the at least one vehicle, the one or more other vehicles, or a combination thereof, (b) a representation of a traffic warning associated with the path of travel, the at least one vehicle, the one or more other vehicles, or a combination thereof, or (c) a combination thereof.

21.-48. (canceled)
